(19) United States
(12) Patent Application Publication
(10) Pub. No.: US 2010/0207452 A1
(43) Pub. Date: Aug. 19, 2010

(54) MOBILE HYBRID ELECTRICAL POWER SOURCE

(76) Inventor: Antoine Saab, Montreal (CA)

Correspondence Address: LITMAN LAW OFFICES, LTD., POST OFFICE BOX 41200, SOUTH STATION, ARLINGTON, VA, 22204, US

(21) Appl. No.: 12/733,852

(22) PCT Filed: Sep. 26, 2008
(86) PCT No.: PCT/US08/11220

§ 371 Date: Mar. 24, 2010

Related U.S. Application Data
(60) Provisional application No. 60/960,435, filed on Sep. 28, 2007.

(51) Int. Cl. H02J 3/38

(52) U.S. Cl. 307/65

(57) ABSTRACT

The mobile hybrid electrical power source (100) is reconfigurably disposed in a street-legal size compact metallic container (105) positioned on a hydraulic trailer (107) that can be towed by a truck. An alignment pin (109) is provided on the container (105) for aligning and mating the container with a rotary bearing (111) on the trailer (107). The rotary bearing (111) allows the metallic container (105) to rotate about a vertical central axis +/−180° from an initial position of the container (105). The generator (100) combines a plurality of power sources to provide optimal operation in multiple applications and conditions. The power sources comprise wind, solar, and fossil fuel energy components. When a power grid is available, the mobile hybrid electrical power source (100) can be connected to the grid to sell energy back to the grid.

### TECHNICAL FIELD

The present invention relates to electrical power sources, and more particularly, to a mobile hybrid electrical power source providing wind, diesel and photovoltaic electrical generation.

### BACKGROUND ART

With the development of computers and their growing critical use in commercial, industrial, chemical and military machinery and equipment, it is becoming an absolute necessity to develop adapted power generation solutions to power such equipment when deployed in remote areas where standard grid connect power supplies are unavailable (no grid power available in vicinity of site).

To date, fossil fuel powered generators are used to power these applications. However, they have a substantial number of drawbacks, including high initial, maintenance and fuel costs.

Generators are mechanical devices that erode with time. Mechanical failures often occur, and, as a result, critical loads for remote sites in extreme weather condition require at least two generators to minimize the risk of failure of one unit. Moreover, generators cannot function 24/7 without any interruption. At least two generators are usually needed to insure 24/7 power availability. When more than one generator is used to supply power to a site, control circuitry must also be installed to manage and protect the system. A number of oil tanks are also needed making the overall initial costs quite high.

Generators have very high maintenance and operating costs. Generators require the continuous presence of at least one technician capable of performing repairs, together with spare parts. They also consume a nearly constant amount of fuel per hour independently of the load. This translates into substantial costs of fuel at all times even in the event where power consumption may be very low.

Fossil fuel-powered generators cause environment pollution. Such generators are very polluting as they operate diesel and function 24/7. Moreover, due to their dependence on fossil fuel, such generators require the availability of fuel. If a source of fuel is not available in the vicinity of the site, it is not possible to depend on a generator more than a few weeks. Additionally, due to the necessity for a constant line of refueling, even in the event where a source of refueling is available, it is quite costly to establish a continuous line of refueling as this requires trucks and human resources to move fuel from the source to the generator constantly.

Fossil fuel-powered generators create a lot of noise. Because such a generator is very noisy, it may be of nuisance to staff and workers, especially at night.

Since fossil fuel-powered generators are incompatible with critical load, they may not be capable of delivering the smooth and clean power required by electronic devices and computers. Furthermore, such generators cannot be made “uninterrupted” even when two units are installed on site (there is always a small power loss when load is transferred from one generator to the other). It is therefore necessary to install UPS (uninterrupted Power Supplies) between the generator and the critical load in order to make sure that even if the generator has to be stopped for a while or the load is to be transferred from one generator to the other, there will be no interruption of the load. For critical applications, redundant UPS systems must be used in order to guarantee the up-time of the load. All of the aforementioned problems result in increasing both the initial costs and maintenance costs further.

Thus, a mobile hybrid electrical power source solving the aforementioned problems is desired.

### DISCLOSURE OF INVENTION

The mobile hybrid electrical power source is reconfigurably disposed in a street-legal size compact metallic container positioned on a hydraulic trailer that can be towed by a truck. An alignment pin is provided on the container for aligning and mating the container with a rotary bearing on the trailer. The rotary bearing allows the metallic container to rotate around a vertical central axis +/−180° from an initial position of the container. The system combines a plurality of power sources to provide optimal operation in multiple applications and conditions. The power sources comprise wind, solar, and fossil fuel energy components. When a power grid is available, the mobile hybrid electrical power source can be connected to the grid to sell energy back to the grid.

These and other features of the present invention will become readily apparent upon further review of the following specification and drawings.

### BRIEF DESCRIPTION OF THE DRAWINGS

FIG. 1 is an environmental, perspective view of a mobile hybrid electrical power source according to the present invention

FIG. 2 is a top view of the mobile hybrid electrical power source according to the present invention.

FIG. 3 is a partially exploded side view of the mobile hybrid electrical power source according to the present invention, showing the trailer and container for the power source.

FIG. 4 is a side view showing the trailer and container of FIG. 3 when attached to each other.

FIG. 5 is a rear view of the mobile hybrid electrical power source according to the present invention, showing the hydraulic feet retracted.

FIG. 6 is a rear view of the mobile hybrid electrical power source according to the present invention, showing the hydraulic feet extended.

FIG. 7 is a top view showing the rotational positioning of the trailer of the mobile hybrid electrical power source according to the present invention.

FIG. 8 is a rear view showing the first stage of wind turbine deployment of the mobile hybrid electrical power source according to the present invention.

FIG. 9 is a rear view showing the second stage of wind turbine deployment of the mobile hybrid electrical power source according to the present invention.

FIG. 10 is a rear view showing the final stage of wind turbine deployment of the mobile hybrid electrical power source according to the present invention.

FIG. 11 is a rear view showing the first stage of solar panel deployment of the mobile hybrid electrical power source according to the present invention.

FIG. 12 is a rear view showing the second stage of solar panel deployment of the mobile hybrid electrical power source according to the present invention.

FIG. 13 is a rear view showing the third stage of solar panel deployment of the mobile hybrid electrical power source according to the present invention.

FIG. 14 is a rear view showing the fourth stage of solar panel deployment of the mobile hybrid electrical power source according to the present invention.

FIG. 15 is a rear view showing the fifth stage of solar panel deployment of the mobile hybrid electrical power source according to the present invention.

FIG. 16 is a top view showing a plurality of mobile hybrid electrical power sources connected together according to the present invention.

FIG. 17 is a side view of the mobile hybrid electrical power source according to the present invention, showing configuration of the components.

FIG. 18 is a rear view of the mobile hybrid electrical power source according to the present invention, showing hydraulic configuration of the wind and solar components.

FIG. 19 is a front view of the wind and solar panel control panel of the mobile hybrid electrical power source according to the present invention.

FIG. 20 is a block diagram of the electrical circuitry of the mobile hybrid electrical power source according to the present invention.

Similar reference characters denote corresponding features consistently throughout the attached drawings.

### BEST MODES FOR CARRYING OUT THE INVENTION

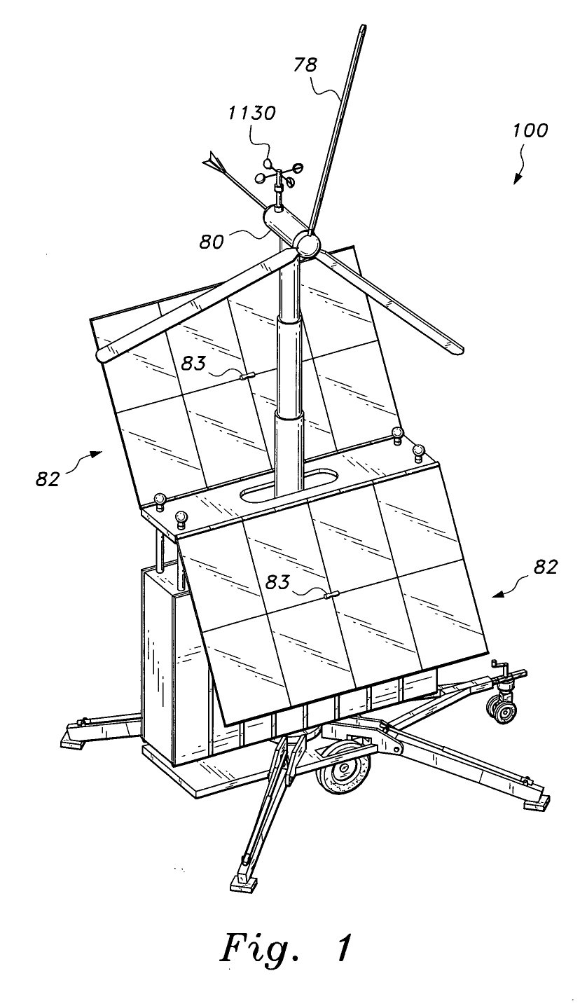

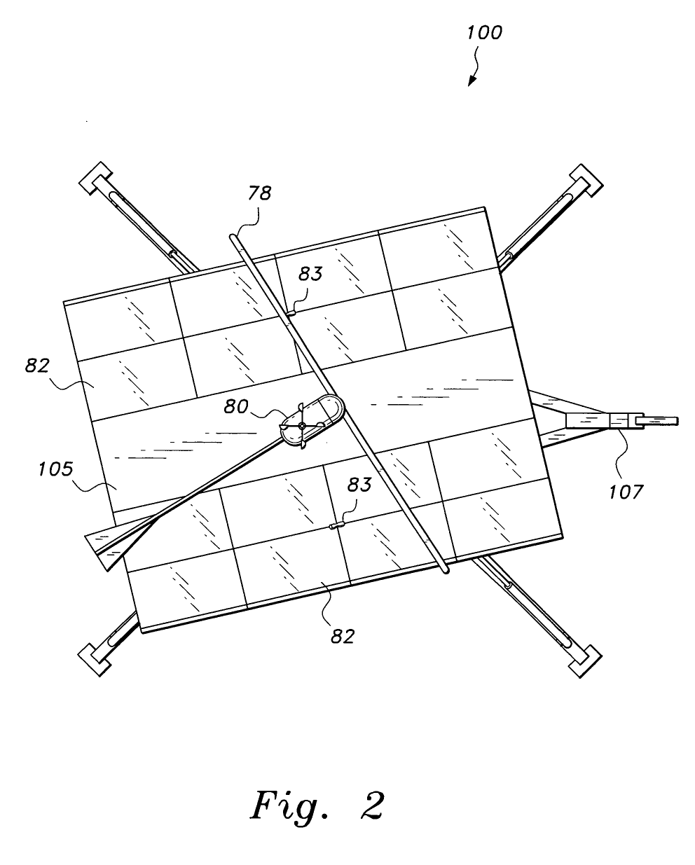

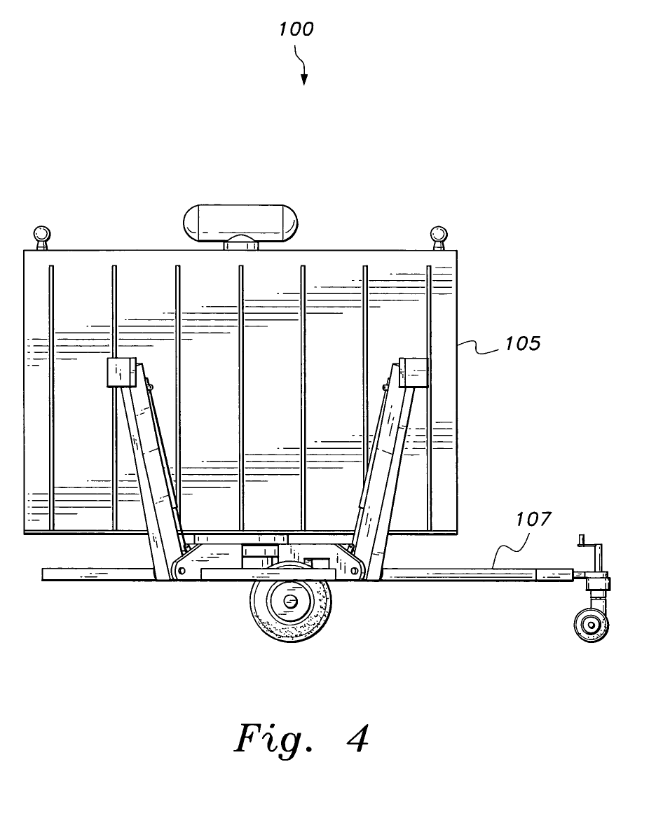

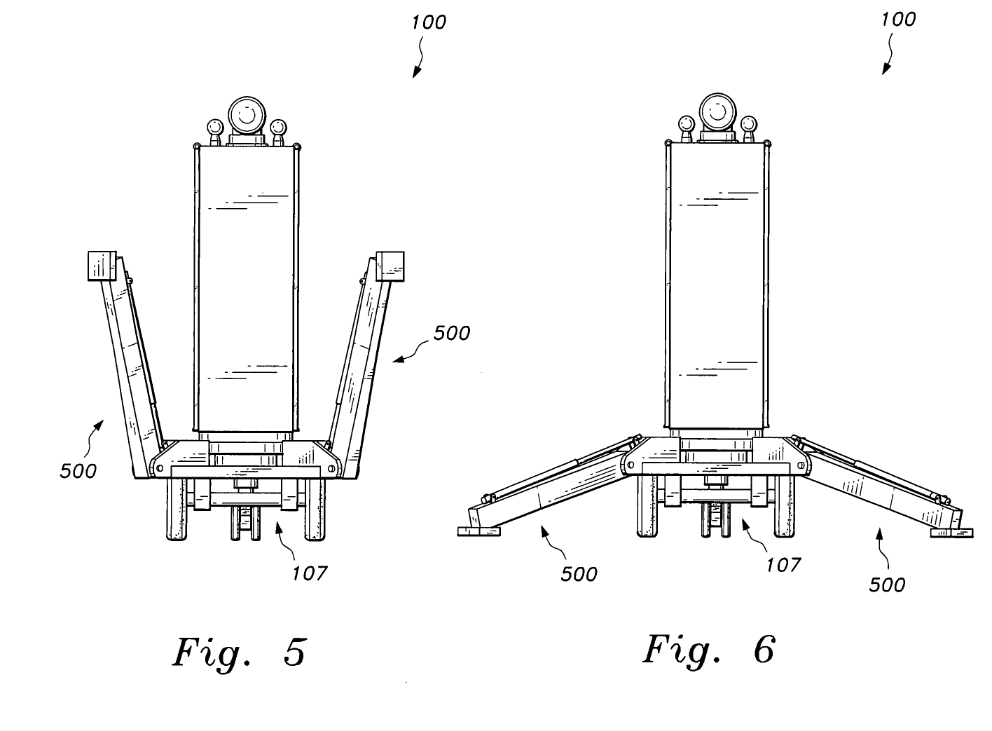

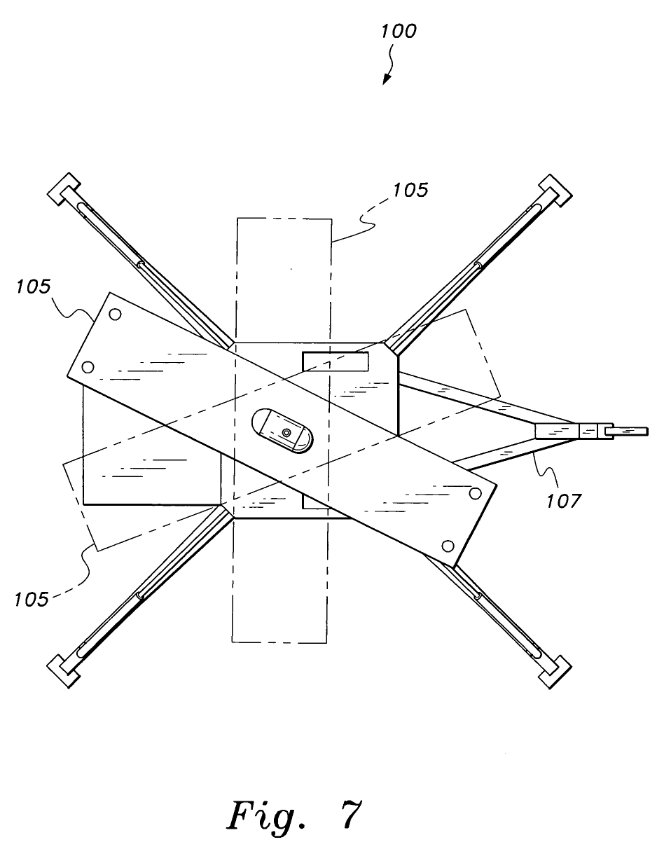

As shown in FIGS. 1-6, the present invention is a mobile hybrid electrical power source 100 disposed in a compact, preferably metallic, container 105 preferably having dimensions that do not exceed H95″(241 cm)×W163″(414 cm)×D50″(127 cm) in order to make the device legal for street use in most jurisdictions. It sits atop a hydraulic trailer 107 that can be towed by a truck for ease of transport and deployment. Instead of a hydraulic trailer, the container 105 may be mounted on any suitable mobile platform, such as a flat-bed truck, a flat-bed railroad car, or any other mobile support platform. The container 105 of the mobile hybrid electrical power source 100 is installed in factory on its trailer 107 using a crane which drops the container 105 onto the trailer 107 while aligning the male pin 109 extending from the container 105 with a designated female rotary bearing 111 of the trailer 107. As shown in FIG. 7, this rotary bearing 111 allows the container 105 to rotate around its vertical central axis +/−180° degrees from its initial position (aligned with trailer 107).

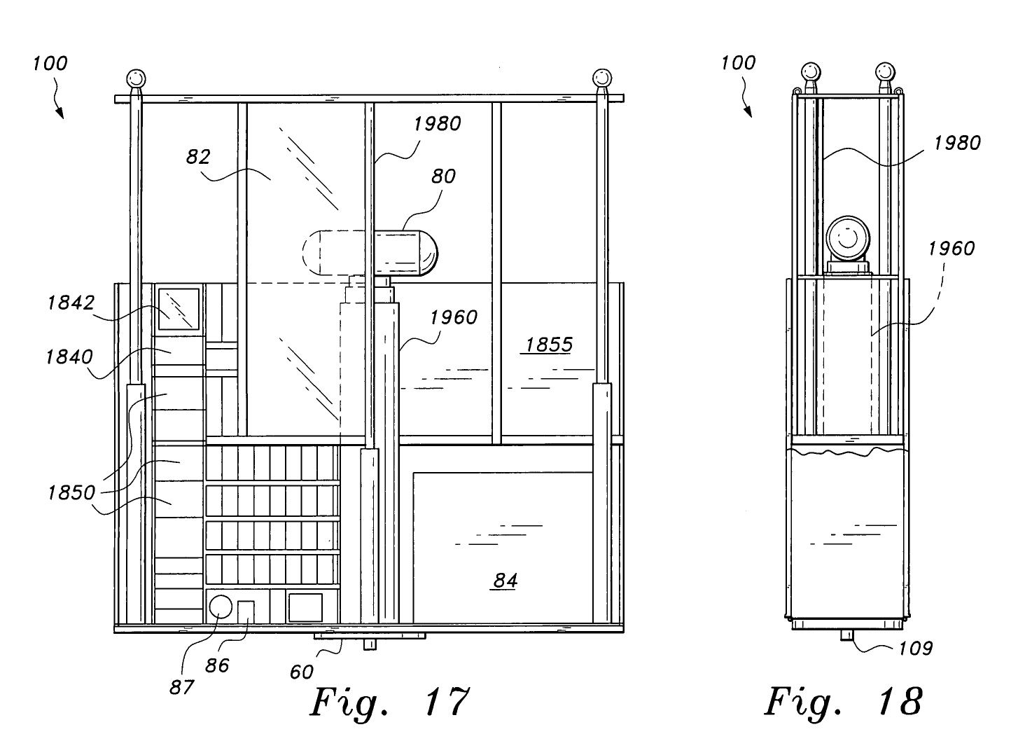

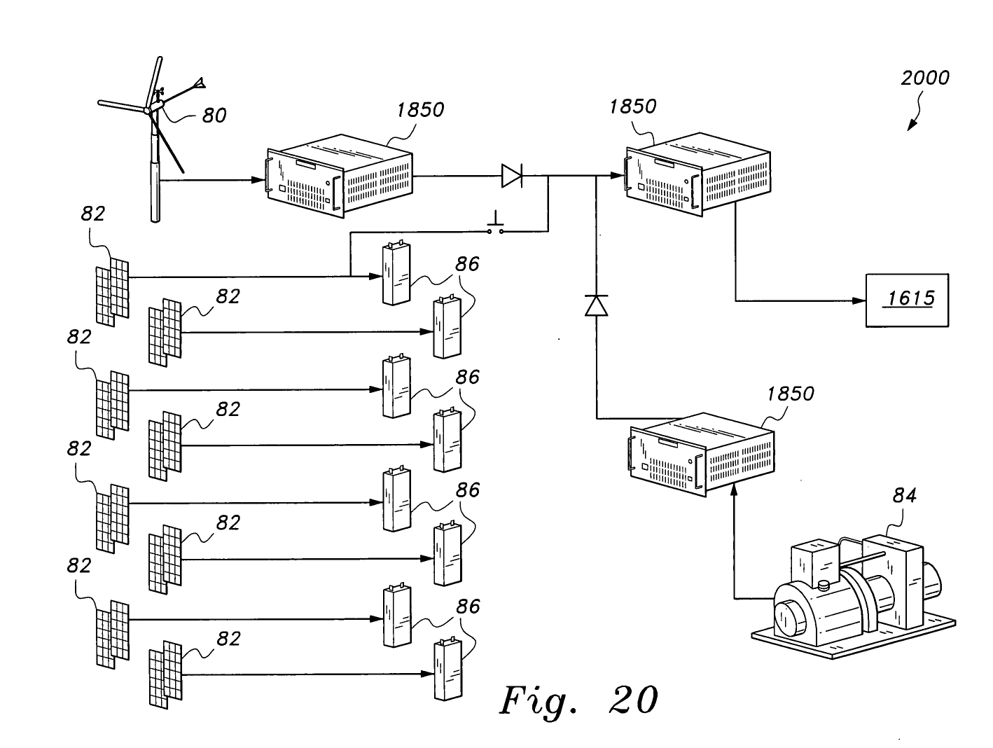

As shown in FIG. 20, a plurality of energy sources may be combined together to provide optimal power generation in multiple applications and conditions. Power is managed and controlled via controller/rectifiers 1850. These energy sources may comprise wind energy which is collected using a wind turbine 80, solar energy which is collected using deployable solar panel structure 82, fossil fuel burning generator 84 which, as shown in FIG. 17 is positioned inside the container 105, energy stored in batteries 86 positioned inside the container 105, and optionally, energy collected from a utility power grid when available. Fuel tank 1855 supplies diesel, gasoline, bio-diesel, or other fossil fuel to generator 84. Moreover, when a power grid is available, the mobile hybrid electrical power source can be connected to the grid to sell energy back to the grid.

Wind and solar energy are always considered a priority over fossil fuel burning generator 84 and power grid. The fossil fuel burning generator 84 preferably will not be started until a battery level is depleted and the grid is not connected. Batteries 86 preferably will charge from the unused power before delivering excess energy to the grid (if connected).

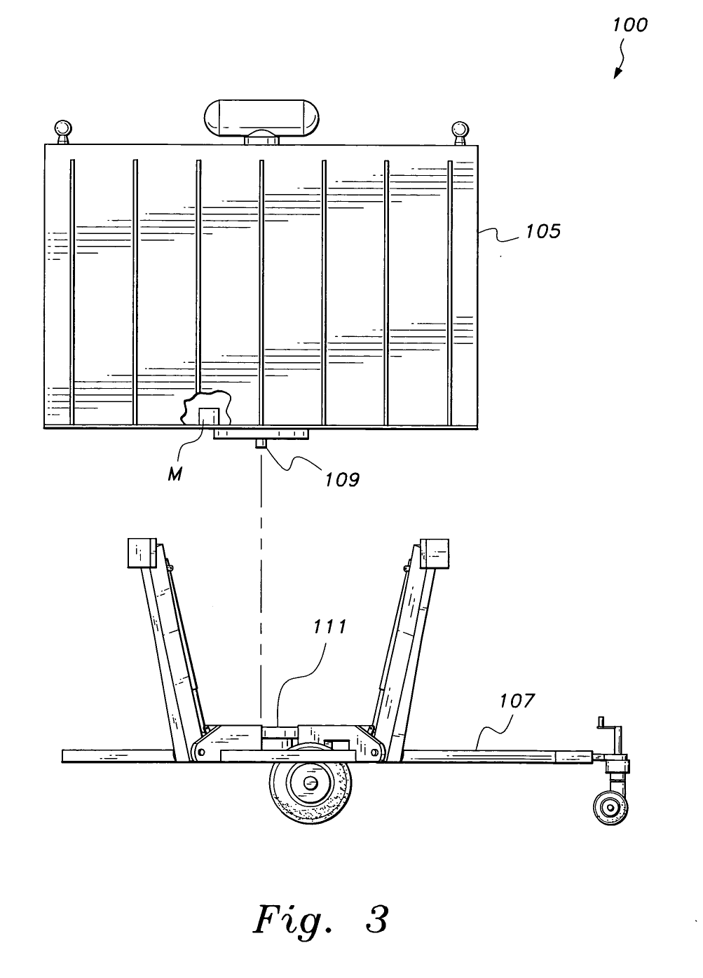

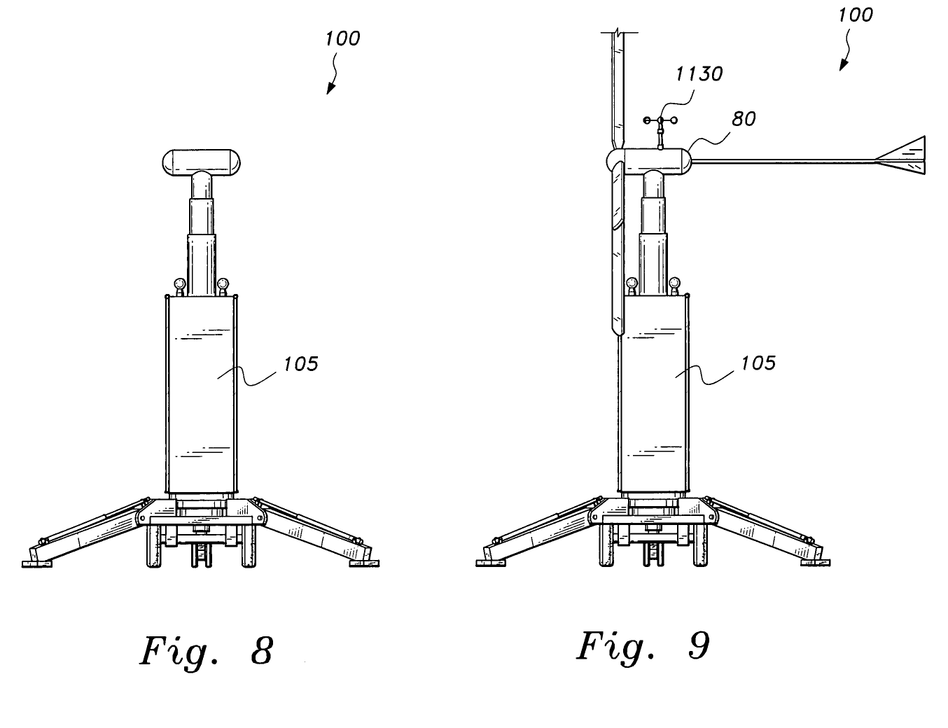

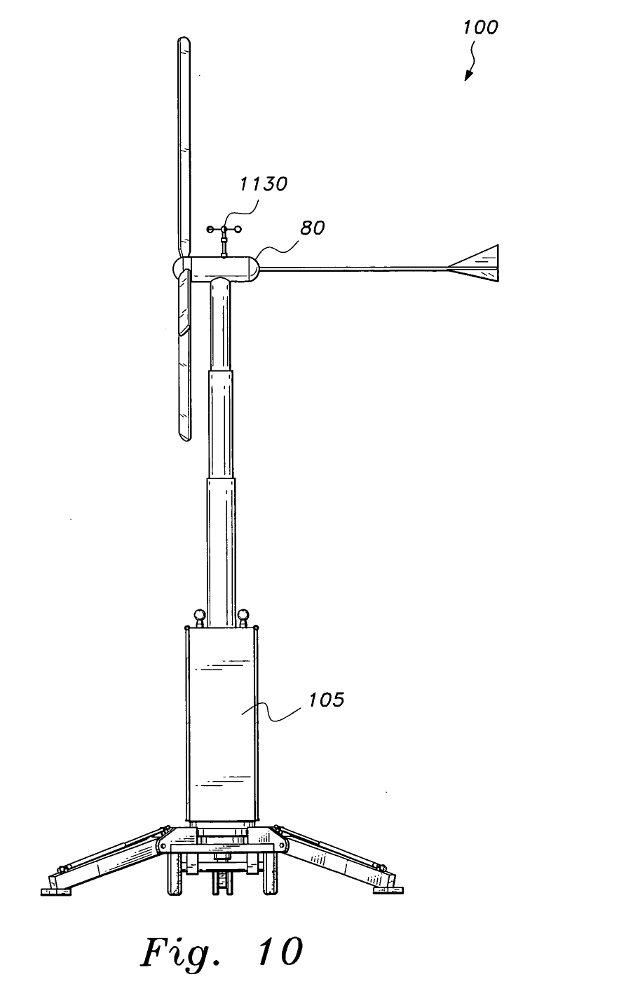

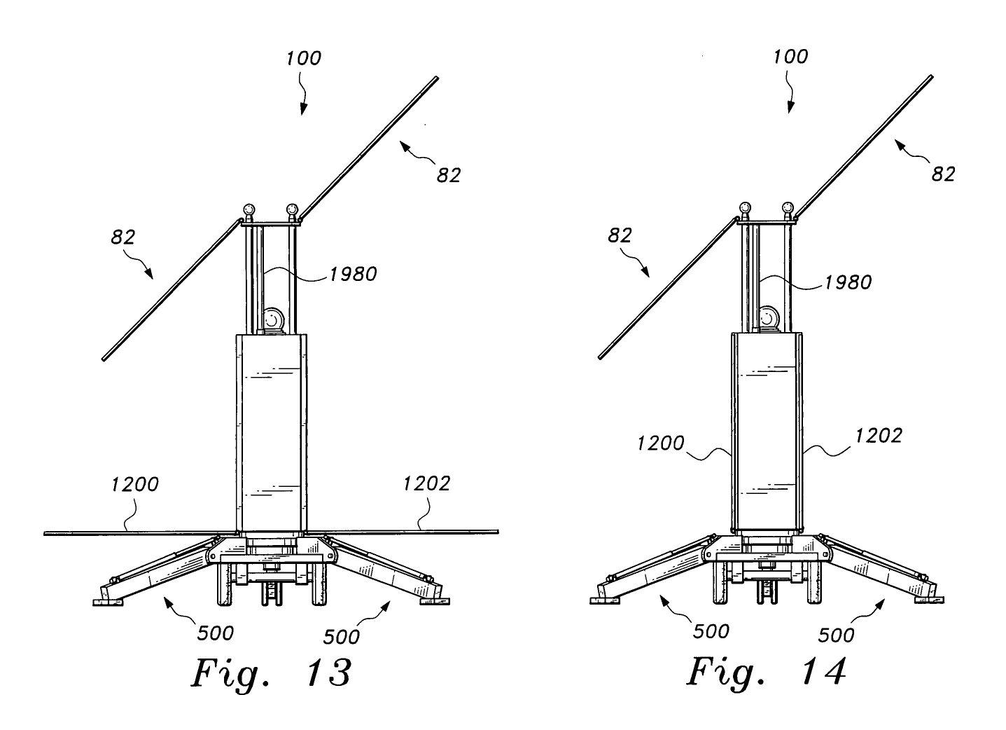

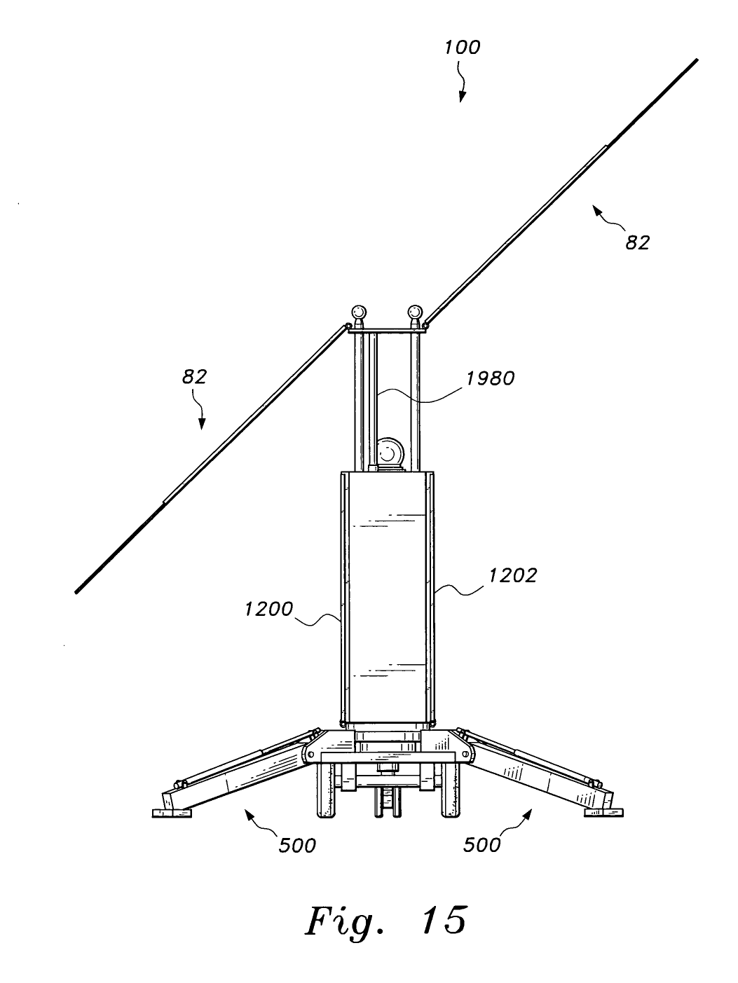

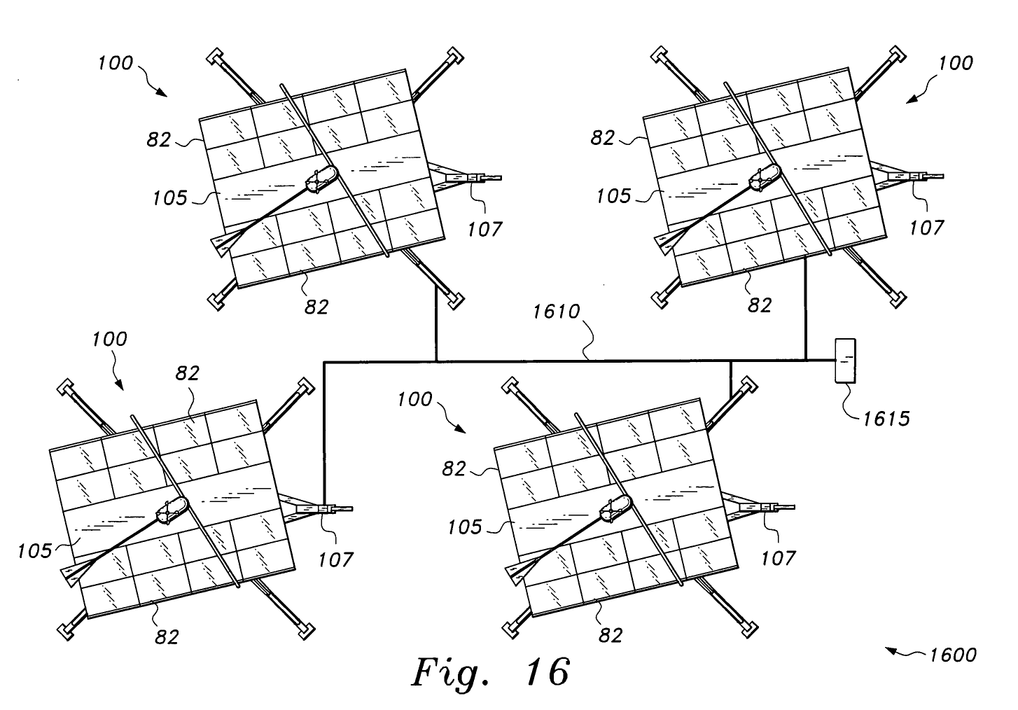

The mobile hybrid electrical power source 100 is capable of automatically tracking the sun horizontally and vertically in order to optimize energy collection. The turbine 80 is also capable of rotation around itself while adjusting blade pitch for optimum power generation. The solar panel structure 82 and wind turbine 80 move independently from each other. As shown in FIGS. 3-15 and 20 a plurality of electronic circuitry, electromechanical and mechanical components are utilized in the design of the mobile hybrid electrical power source 100.

An exemplary mobile hybrid electrical power source 100 is capable of providing 10 KW of total power. The device 100 may be scaled up or scaled down to provide higher or lower power generating capacity. Moreover, as shown in FIG. 16, a plurality of mobile hybrid electrical power sources 100 can be connected together via power cable 1610 in order to increase the power. Cable 1610 may be connected to an electrical feed terminal 1615 through which 127V/220V at 40 KW may be connected to a utility power grid to either supply power to the grid or take power from the grid. Exemplary power output configurations include 100/173V 50/60 Hz, 110/193V 50/60 Hz, 120/208V 60 Hz, 127/220V 60 Hz, 220/380V 50/60 Hz, 230/400V 50/60 Hz and 240/415V 50/60 Hz. Using the exemplary 10 KW capacity, two mobile hybrid electrical power sources 100 can provide 20 KW, three mobile hybrid electrical power sources 100 can provide 30 KW, and the like.

Redundant control electronic circuitry is provided to control the system 100 when more than one mobile hybrid electrical power source 100 is used. This means that if N+1 mobile hybrid electrical power sources 100 are connected together to a load consuming a power of N×10 KW, the failure of any one mobile hybrid electrical power source 100 at any given time will not disrupt the operation of the load. Similarly in the event where a load of (N−1)×10 KW is connected, the simultaneous failure of two mobile hybrid electrical power sources 100 will not disrupt the system. The redundant control electronic circuitry ensures that as the load decreases, the system reliability increases thereby providing power capability in highly critical applications such as like oil industry operations, military operations, or the like.

The system 100 provides interface electronic circuitry so that only two persons at most are needed to configure, deploy, and operate the mobile hybrid electrical power source 100. Once the mobile hybrid electrical power source 100 is positioned on site where it is to be deployed, the hydraulic feet 500 of the trailer 107 can be activated to take solid grip on the ground.

As shown in FIG. 19, a plurality of keys, preferably two keys are disposed on an outer surface of the container. A first key 1902 activates the wind turbine electric generating system. A second key 1904 activates the solar electric generating system. First and second keys 1902 and 1904 may have a plurality of positions including “MANUAL” and “AUTO” (automatic).

When key 1902 or 1904 are turned to position “MANUAL” or position “AUTO”, a pneumatic compressor is activated. The pneumatic compressor provides air pressure via an air pressure tank 87 to a main pneumatic cylinder 1960 that holds wind turbine 80. Pressure control electronic circuitry is connected to the pneumatic compressor in order to maintain constant pressure. A pressure gauge that constantly measures the pressure inside an air tank is used as feedback input to the pressure control electronic circuitry so that a constant pressure can be maintained. Referring to FIGS. 8-10 and 18-19, a lever 2000 is provided and is connected to pneumatic circuitry that manually raises the turbine 80 above the container 105 by approximately three feet (one meter) via pneumatic cylinder 1960 responsive to upward movement of the lever 2000. This allows a user to thread blades 78 on to the turbine 80. Additional control circuitry is provided so that when the same “UP” portion of lever 2000 is pressed again, via cylinder 1960, the turbine rises up to 25 ft (or more depending on the capacity of cylinder 1960) above ground to thereby place the turbine 80 in the wind stream for wind power generation. Via automatic mode electronic control circuitry, the “Auto” mode of the key 1902 activates computer control over the turbine height. The computer 1840 (shown in FIG. 17) then monitors the air speed and retracts the turbine 80 if the air speed is excessive. It should be understood that in lieu of or in addition to pneumatic control, system 100 may use hydraulic actuation (including a reservoir of hydraulic fluid, a hydraulic pump, hydraulic valves and switching, and hydraulic ram(s) or cylinder(s)), electrical actuation, or the like to control the various mechanical systems described herein. The computer has a display 1842 to present system user interfaces. Time delay electronic control circuitry is provided so that the turbine 80 will only start turning after approximately 30 seconds (or some other predetermined delay time) from being switched into AUTO mode.

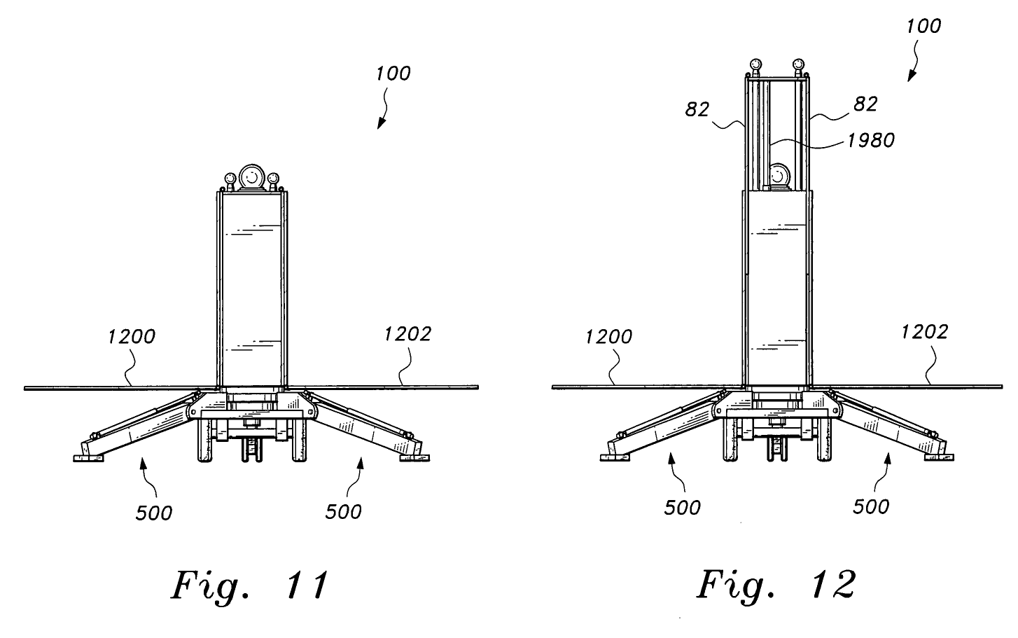

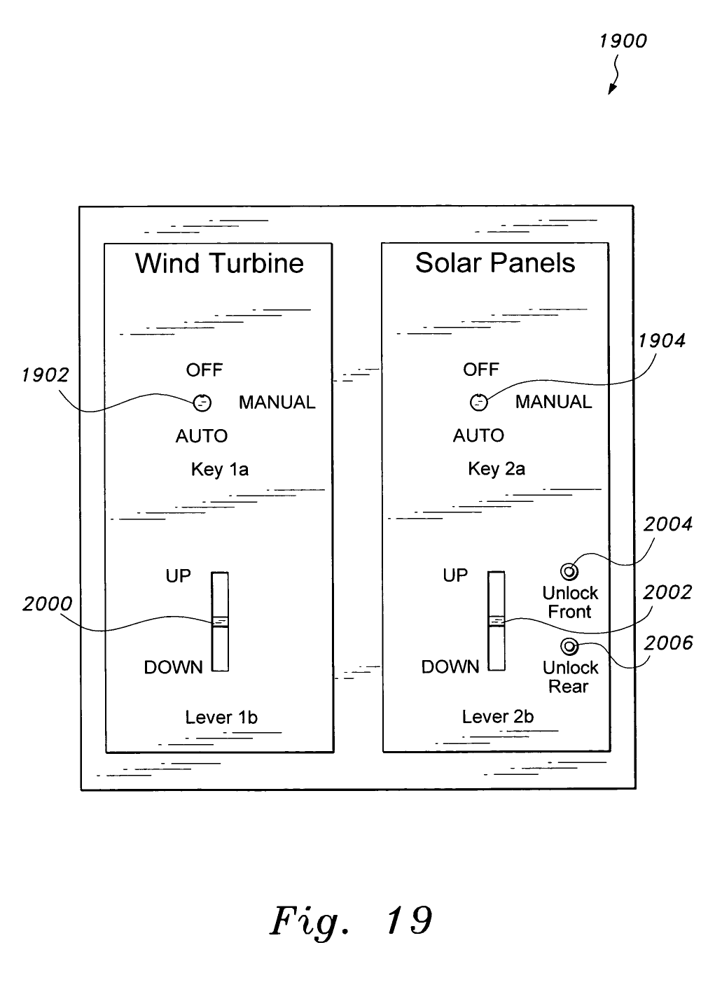

As shown in FIGS. 11-15 and 19, the “Manual” position of key 1904 and the “Unlock Front” button 2004 function in tandem to send a signal to a controller of front lateral door 1200. This causes the hinged front lateral door 1200 to unlock and slowly unfold into a horizontal position. Button “Unlock rear” 2006 will release the rear protecting door 1202 which will also unfold into a horizontal position. Lever 2002 permits manual positioning of the solar panel structure 82 up and down by controlling the pressure in cylinder 1980 (shown in FIG. 18). If Key 1904 is turned into position “AUTO”, the computer 1840 will control the pressure inside cylinder 1980 (either pneumatic or hydraulic actuators may be used to raise and lower the solar panels, as described above with reference to raising and lowering the wind turbine) raising the solar panel structure 82 upwards toward a maximum height position, and then deploy the solar panels in the ideal position for optimal solar energy collection. Computer 1840 determines the ideal position of each solar area independently by constantly monitoring the outputs of a small solar tracking device 83 positioned in the center of each solar array. Then computer 1840 will command the protective doors 1200 and 1202 to fold back in order to protect the interior of the container against dust and wind. Computer 1840 automatically raises front solar array in solar panel structure 82 momentarily in order to safely fold front lateral door 1200 without touching the solar array. Deployment of a second row of panels in solar panel structure 82 is then controlled by a step motor until all panels reach their maximum exposure. Once this is done, the computer will activate the rotary motor 60 to turn the entire container in the optimal direction with respect to the sun. The system 100 can update its horizontal and vertical tracking every 10 minutes (or any other pre-programmed value between 1 minute and 24 hours) for an optimal solar energy collection. It is possible to use the system 100 to collect solar energy only, wind energy only, or wind and solar energy together by using key 1902 and key 1904 as detailed above.

Once key 1902 and key 1904 are in position “AUTO”, the system 100 will constantly monitor wind speed by reading the speed of wind and its direction using an anemometer 1130 positioned on the top of the wind turbine 80. The computer 1840 will constantly make decisions on the proper course of action to be taken in every wind speed direction and strength. In a strong wind situation, the computer 1840 will retract one level of solar panels while keeping the wind energy running in normal condition.

If wind increases further, solar panel 82 will be deployed and the wind turbine 80 retracted to a lower position as determined by the computer 1840 for safe operations. In extreme conditions the turbine will be stopped and the solar panels 82 will be automatically retracted and covered by the lateral doors 1200 and 1202. The panels 82 will automatically re-deploy after the computer 1840 senses 60 minutes (or any other time value as pre-programmed in the computer 1840) of acceptable weather conditions. Two dimensional solar tracking is provided to increase solar collection efficiency.

The mobile hybrid electrical power source system 100 is pre-assembled, thereby obviating on site assembly problems. The system 100 is capable of controlling its shape to optimize energy generation under current wind speeds. The system 100 is constructed to be storm/hurricane level four proof. Via anemometer 1130 transmission of wind data to computer 1840, and computer 1840 responsive processing, the system 100 is capable of sensing high wind speeds (>110 km/h) and retracting the wind mill 80 and solar panels 82 while still providing power from batteries 86 or fossil fuel powered electric generator 84 during the storm. The on board computer 1840 of system 100 constantly monitors all components and can sense an alarm condition in the case of abnormalities. An SMS text message and e-mail can be sent automatically to a pre-defined number of people in case of an alarm. Connection to the Internet is achieved via an optional duplex communication device that can be installed on the top of the mobile hybrid electrical power source. This device may be comprised of a wireless microwave link, VSAT satellite connection, wireless access point (WAP), or the like, to achieve 2 way communication to the Internet. When this option is installed, it is possible for a remote administrator to remotely monitor and control the system 100. Software can also allow the remote administrator to contemporaneously monitor and control a plurality of systems 100 positioned in different geographic areas.

It is to be understood that the present invention is not limited to the embodiment described above, but encompasses any and all embodiments within the scope of the following claims.

1. A mobile hybrid electrical power source, comprising:
a mobile platform having hydraulically activated stabilizer legs;
a container rotatably mounted atop the mobile platform;
a wind energy extraction device rotatably disposed in the container;
means for extending and retracting the wind energy extraction device from and to the container, respectively;
a solar energy extraction device disposed in the container;
means for extending and retracting the solar energy extraction device from and to the container, respectively;
a plurality of batteries disposed within the container;
a fuel-burning electric generator disposed within the container; and
power management means for managing electric power generated from the wind energy extraction device, the solar energy extraction device, the plurality of batteries, and the fuel-burning electric generator.

2. The mobile hybrid electrical power source according to claim 1, wherein the container dimensions do not exceed approximately 241 cm high, 414 cm wide, and 127 cm deep, the container having said dimensions being street legal in most jurisdictions.

3. The mobile hybrid electrical power source according to claim 1, wherein the rotatably mounted container can rotate around its vertical central axis +/−180° degrees from its initial position.

4. The mobile hybrid electrical power source according to claim 1, further comprising a solar tracking device operably connected to the solar energy extraction device, the solar tracking device automatically tracking the sun horizontally and vertically in order to optimize energy collection.

5. The mobile hybrid electrical power source according to claim 1, wherein the power management means comprises control/rectification of the disparate power generation devices available to the mobile hybrid electrical power source.

6. The mobile hybrid electrical power source according to claim 1, wherein the wind and solar energy extraction devices are prioritized over the fuel burning generator as a power source provided by the device.

7. The mobile hybrid electrical power source according to claim 1, wherein active solar energy extraction members and active wind energy extraction members can move independently from each other.

8. The mobile hybrid electrical power source according to claim 1, wherein a plurality of mobile hybrid electrical power sources are connected together, thereby increasing the total power output of the devices.

9. The mobile hybrid electrical power source according to claim 8, further comprising redundant control electronic circuitry adjusting power output of the device when any of the plurality of devices fails.

10. The mobile hybrid electrical power source according to claim 1, further comprising interface electronic circuitry so that only two persons at most are needed to configure, deploy, and operate the mobile hybrid electrical power source.

11. The mobile hybrid electrical power source according to claim 10, wherein the interface electronic circuitry comprises a plurality of keys, each of the keys activating a separate electric power extraction/generating mode.

12. The mobile hybrid electrical power source according to claim 11, further comprising an on-board computer operably connected to the keys wherein one of the plurality of keys operates first and second modes of deployment of the wind energy extraction device, first mode being manual allowing an operator to determine a deployment height of the wind energy extraction device, second mode being auto allowing the computer on-board the mobile hybrid electrical power source to determine a deployment height of the wind energy extraction device.

13. The mobile hybrid electrical power source according to claim 12, wherein in the auto mode, the computer determines a safe deployment height based on environmental airspeed, the computer retracting the wind energy extraction device if the air speed is excessive.

14. The mobile hybrid electrical power source according to claim 13, further comprising time delay electronic control circuitry starting the wind energy extraction device after a predetermined delay time from being switched into AUTO mode.

15. The mobile hybrid electrical power source according to claim 11, wherein one of the plurality of keys operates first and second modes of deployment of the solar energy extraction device first mode being manual allowing an operator to manually determine a deployment position of the solar energy extraction device, second mode being auto allowing a computer on-board the mobile hybrid electrical power source to determine a deployment position of the solar energy extraction device.

16. The mobile hybrid electrical power source according to claim 15, wherein the computer determines a deployment configuration of the solar energy extraction device based on environmental airspeed, the computer rearranging the deployment configuration to maintain a safe operating height and position.

17. The mobile hybrid electrical power source according to claim 16, wherein in extreme weather environmental conditions the wind energy extraction device is stopped and the solar energy extraction device is automatically retracted and covered, the energy extraction devices automatically re-deploying after the computer senses a predetermined time of acceptable weather conditions.

18. The mobile hybrid electrical power source according to claim 17, wherein power is provided from the batteries/fuel powered electric generator when the solar and wind extraction devices are deactivated.

19. The mobile hybrid electrical power source according to claim 12, further comprising a messaging system operably connected to the computer, the computer constantly monitoring all components, sensing alarm conditions, and alerting personnel via the messaging system in case of an alarm.

20. The mobile hybrid electrical power source according to claim 12, further comprising a duplex communication device operably connected to the computer, the duplex communication device facilitating network communication of the mobile hybrid electrical power source to a remote location wherein the power source can be remotely administered.
